(19) United States
(12) Patent Application Publication
(10) Pub. No.: US 2026/0200246 A1
(43) Pub. Date: Jul. 16, 2026

(54) PRINTING APPARATUS

(71) Applicant: CANON KABUSHIKI KAISHA, Tokyo (JP)

(72) Inventor: MIDORI YASUDA, Kanagawa (JP)

(21) Appl. No.: 19/448,619

(22) Filed: Jan. 14, 2026

(30) Foreign Application Priority Data
Jan. 15, 2025 (JP) 2025-005357

(51) Int. Cl. B41J 11/00; B41J 15/04; B41J 29/48

(52) U.S. Cl. CPC B41J 11/0095; B41J 15/04; B41J 29/48

(57) ABSTRACT

A printing apparatus includes: a roll holding unit configured to hold a roll on which a sheet is wound, such that the roll is rotatable in a first rotation direction for feeding out the sheet and in a second rotation direction opposite to the first rotation direction; a motor configured to rotate the roll held by the roll holding unit in the first rotation direction or the second rotation direction; a control unit configured to control the motor; an obtaining unit configured to obtain an outer diameter of the roll held by the roll holding unit; and a notification unit configured to provide a notification about a remaining length of the sheet on the roll held by the roll holding unit, based on the outer diameter of the roll obtained by the obtaining unit.

### BACKGROUND

### Field of the Technology

The present disclosure relates to a technology for printing an image on a sheet fed out from a roll.

### Description of the Related Art

Printing apparatuses (image forming apparatuses) used for banner printing, printing of large posters, and the like may perform printing on a sheet that is several meters to several tens of meters long and fed out from a roll. Printing on such a long sheet is referred to as long-length printing. In order to prevent printing apparatuses from stopping during printing due to a shortage of the remaining portion of a sheet fed out from a roll, printing apparatuses that perform long-length printing include a function of managing the remaining portion of a sheet. Note that the remaining portion of a sheet is the remaining length of the sheet on a roll. For example, Japanese Patent Laid-Open No. 2010-132419 (Literature 1) discloses calculating a remaining amount of a medium, based on a rotation amount of a roll, a conveyance amount of a medium such as a sheet, and a thickness of the medium.

However, in the method disclosed in Literature 1, it is necessary to feed out the medium from the roll in order to obtain a conveyance amount of the medium. For this reason, in a case where the roll is replaced while the remaining amount of the medium is insufficient, it has been necessary to rewind the medium.

### SUMMARY

The present disclosure aims to provide a technology that makes it possible to know a remaining length of a sheet on a roll without feeding out the sheet from the roll.

A printing apparatus according to an embodiment of the present disclosure is characterized by including: a roll holding unit configured to hold a roll on which a sheet is wound, such that the roll is rotatable in a first rotation direction for feeding out the sheet and in a second rotation direction opposite to the first rotation direction; a motor configured to rotate the roll held by the roll holding unit in the first rotation direction or the second rotation direction; a control unit configured to control the motor; an obtaining unit configured to obtain an outer diameter of the roll held by the roll holding unit; and a notification unit configured to provide a notification about a remaining length of the sheet on the roll held by the roll holding unit, based on the outer diameter of the roll obtained by the obtaining unit.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating an example of the configuration of a printing apparatus;

FIG. 2 is a schematic cross-sectional view illustrating an example of the configuration of the main part of the printing apparatus;

FIG. 3 is a block diagram illustrating an example of the configuration of a control system in the printing apparatus;

FIG. 4 is a flowchart illustrating an example of the automatic sheet supply processing in the first embodiment;

FIG. 5A and FIG. 5B are schematic diagrams illustrating examples of a screen displayed on an operation panel in the first embodiment;

FIG. 6A and FIG. 6B are schematic diagrams of a roll;

FIG. 7 is a flowchart illustrating an example of the automatic sheet supply processing in the second embodiment;

FIG. 8A and FIG. 8B are schematic diagrams illustrating examples of a screen displayed on the operation panel in the second embodiment;

FIG. 9 is a flowchart illustrating an example of the automatic sheet supply processing in the third embodiment; and

FIG. 10A to FIG. 10C are schematic diagrams illustrating examples of a screen displayed on the operation panel in the third embodiment.

### DESCRIPTION OF THE EMBODIMENTS

Hereinafter, with reference to the accompanying drawings, a detailed description is given of preferable embodiments of the present disclosure. Note that the following embodiments are not intended to limit the contents of the present disclosure, and all combinations of the characteristics described in the following embodiments are not necessarily essential to the solutions provided in the present disclosure. Note that the same configurations are described with the same signs.

### First Embodiment

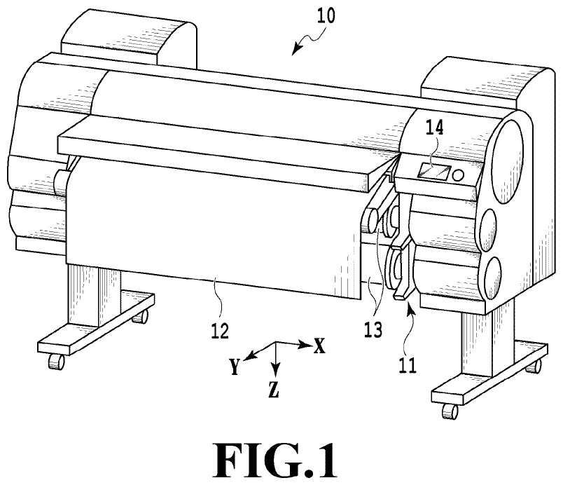

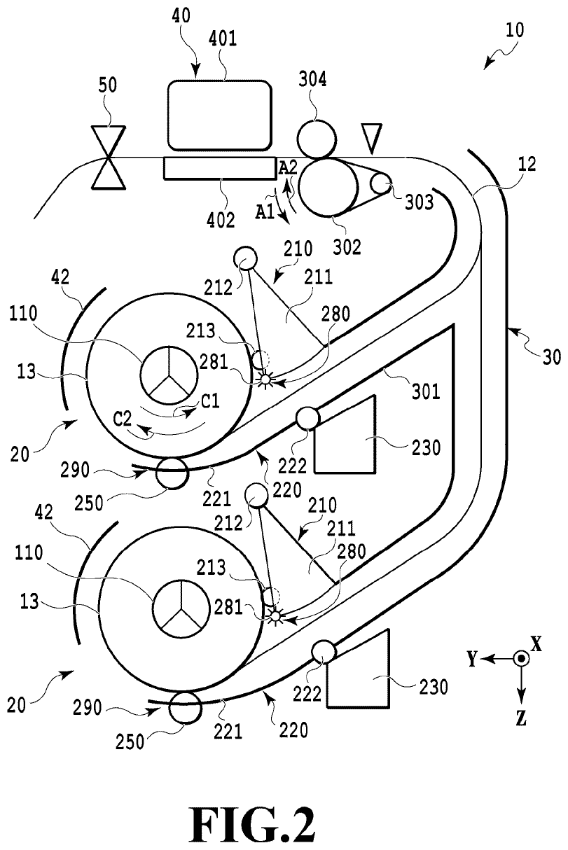

First, with reference to FIG. 1 to FIG. 3, a description is given about the basic configurations of the printing apparatus 10 according to the present embodiment. In FIG. 1 and FIG. 2, the X direction, the Y direction, and the Z direction are defined. The X direction and the Y direction are perpendicular to each other. The Z direction is perpendicular to the X-Y plane. In the present embodiment, the Z direction is the vertical direction.

FIG. 1 is a perspective view illustrating an example of the configuration of the printing apparatus 10. The printing apparatus 10 includes the roll holding unit 11. The roll holding unit 11 holds the roll (roll sheet) 13 on which the sheet 12 serving as a printing medium is wound. In the example of FIG. 1, the roll holding unit 11 is arranged at two locations, namely, the upper portion and the lower portion. The sheet 12 is a long continuous sheet wound into a roll. The rolls 13 can be set in the roll holding units 11 at the upper portion and the lower portion, respectively. An image is printed on the sheet 12, which is selectively fed out from the rolls 13 held by the roll holding units 11 at the upper portion and the lower portion. With this printing apparatus 10, the user can operate various switches on the operation panel 14 to input various commands to the printing apparatus 10, such as designating the type of the sheet 12, designating the width of the sheet 12, and switching between online and offline. The operation panel 14 may be a touch panel.

FIG. 2 is a schematic cross-sectional view illustrating an example of the configurations of the main parts of the printing apparatus 10. In the printing apparatus 10, the two sheet supply units 20 corresponding to the two rolls 13 are arranged one above the other. Each sheet supply unit 20 can automatically separate the leading end of the sheet from the roll 13 and pull it out. The sheet 12 including the leading end separated and pulled out from the roll 13 is conveyed by the sheet conveyance unit 30 to the printing unit 40. The printing unit 40 prints an image on the sheet 12 conveyed along the sheet conveyance path. The sheet 12 with a printed image is cut by the cutter 50. The sheet cut by the cutter 50 includes an image printed by the printing unit 40. Further, the cover 42 on each roll 13 prevents the sheet 12 with a printed image from returning to the sheet supply unit 20.

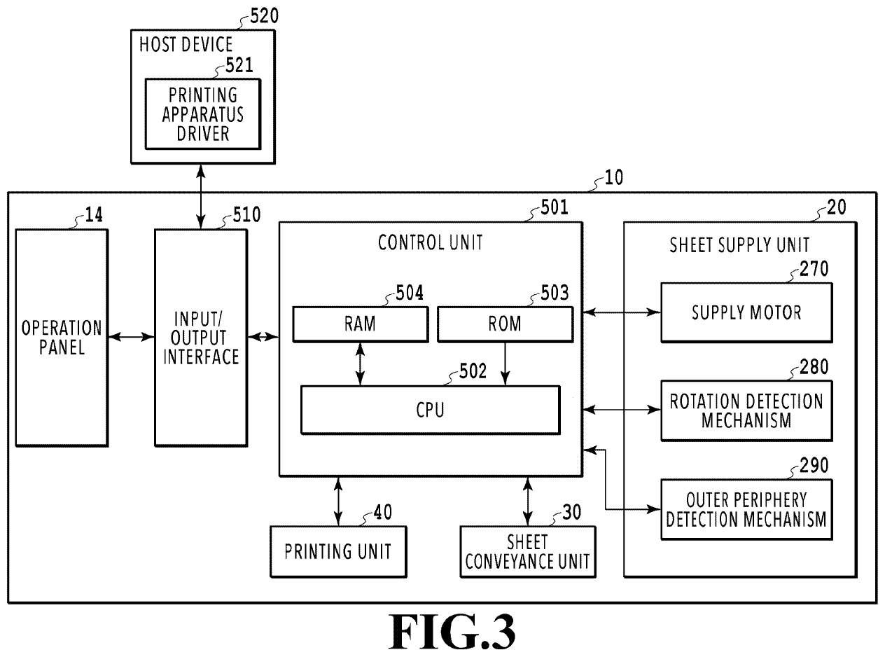

In each sheet supply unit 20, the roll 13 is set in the roll holding unit 11 in a rotatable manner (see FIG. 1). In the example of FIG. 2, the attachments 110 are the members used for setting the rolls 13 in the roll holding units 11 in a rotatable manner. Each attachment 110 can be set in the roll holding unit 11 in a state of being attached to the inside of the hollow hole portion of the roll 13. Each attachment 110 is joined to the hollow hole portion of the roll 13 without any gaps in accordance with the inner diameter (the size of the hollow hole portion) of the roll 13. The inner diameter of each roll 13 is, for example, 2 inches or 3 inches. Each attachment 110, which is selected to match the inner diameter of the roll 13, is attached to the inside of the hollow hole portion from both sides of the roll 13. Each attachment 110 set in the roll holding unit 11 is driven by the supply motor 270 used for driving the roll (see FIG. 3 described below) to rotate in the first rotation direction C1 or the second rotation direction C2 opposite to the first rotation direction C1. If the attachment 110 set in the roll holding unit 11 rotates, the roll 13 rotates in conjunction with the rotation. The members used for setting the rolls 13 in the roll holding units 11 in a rotatable manner are not limited to the attachments 110. For example, the members used for setting the rolls 13 in the roll holding units 11 in a rotatable manner may be spool members that are inserted into the hollow hole portions of the rolls 13.

Further, each sheet supply unit 20 includes the separation flapper 210, the arm member 220, the driving unit 230, and the follower rotating body 250. The separation flapper 210 is attached to the printing apparatus body at a position above the arm member 220. The separation flapper 210 abuts against the outer peripheral surface of the roll 13 by its own weight so as to lightly press the roll 13. To increase the pressing force, a biasing member such as a spring may be used to bias the separation flapper 210. The separation flapper 210 includes the flapper body 211, the flapper rotation shaft 212, and the follower roller 213. The flapper body 211 is rotatable about the flapper rotation shaft 212. The flapper rotation shaft 212 is fixed to the printing apparatus body. The follower roller 213 is attached to the flapper body 211 in a rotatable manner so as to follow the rotation of the roll 13. The follower roller 213 abuts against the roll 13 to suppress an influence on the sheet 12 caused by the pressing force of the flapper body 211 applied to the roll 13.

The arm member 220 is attached to the conveyance guide 301. The space between the arm member 220 and the separation flapper 210 positioned above the arm member 220 serves as a sheet supply port. The sheet 12 fed out from the roll 13 passes through the sheet supply port. The arm member 220 includes the arm body 221 and the arm rotation shaft 222. The arm body 221 is rotatable about the arm rotation shaft 222. The arm body 221 guides the lower surface of the sheet 12 fed out from the roll 13. The arm rotation shaft 222 is fixed to the conveyance guide 301.

The driving unit 230 utilizes the biasing force of a biasing member (not illustrated in the drawings) attached to the driving unit 230 to press the arm member 220 toward the roll 13. The outer diameter of the roll 13 decreases in accordance with the amount of sheet 12 fed out from the roll 13. Since the arm member 220 is pressed by the driving unit 230, even if the outer diameter of the roll 13 decreases, a supply path is formed between the arm member 220 and the separation flapper 210 so that the lower surface of the sheet 12 is guided. Since the separation flapper 210 presses the roll 13 with its own weight, even if the outer diameter of the roll 13 decreases, a supply path is formed between the separation flapper 210 and the arm member 220 so that the upper surface of the sheet 12 is guided. The separation flapper 210 and the arm member 220 rotate to displace in accordance with a change in the outer diameter of the roll 13, and thus, even if the outer diameter of the roll 13 decreases, a supply path having an approximately constant size is formed between the separation flapper 210 and the arm member 220.

The follower rotating body 250 is attached to the arm member 220 in a rotatable manner. The follower rotating body 250 is brought into pressure contact with the outer peripheral portion of the roll 13 from below in the direction of gravity by the pressing force of the driving unit 230. That is, the follower rotating body 250 makes pressure contact with the outer peripheral portion of the roll 13 from below the horizontal central axis of the roll 13 in the direction of gravity. This pressure contact force changes in accordance with the pressing force with which the driving unit 230 presses the arm member 220.

In each sheet supply unit 20, the sheet 12 passes above the follower rotating body 250 and is then fed out from the roll 13. The sheet 12 fed out from the roll 13 is first guided, at its lower surface, by the arm member 220. Then, the sheet 12 is supplied between the arm member 220 and the separation flapper 210. The follower rotating body 250, the separation flapper 210, and the arm member 220 are substantially movable in the radial direction of the roll 13. Therefore, even if the outer diameter of the roll 13 decreases in accordance with the amount of sheet 12 fed out from the roll 13, the sheet 12 can be smoothly supplied.

The sheet conveyance unit 30 includes the conveyance guide 301, the conveyance roller 302, the conveyance motor 303, and the nip roller 304. The conveyance guide 301 guides the front and back surfaces of the sheet 12 fed out from each sheet supply unit 20 while delivering the sheet 12 to the printing unit 40. The conveyance roller 302 is rotated by the conveyance motor 303 in the normal rotation direction A1 or the reverse rotation direction A2. The nip roller 304 rotates as a follower in accordance with the rotation of the conveyance roller 302. With a motor used for adjusting the nipping force, the nip roller 304 can be brought into contact with or separated from the conveyance roller 302, and the nipping force against the conveyance roller 302 can be adjusted. The conveyance speed of the sheet 12 conveyed by the conveyance roller 302 is set to be higher than the speed at which the sheet 12 is fed out by the rotation of the roll 13. In this case, back tension is applied to the sheet 12, and the sheet 12 can be conveyed with the back tension being applied.

The printing unit 40 includes the print head 401 and the platen 402. The print head 401 ejects ink from ejection ports, using ejection energy generating elements such as electrothermal conversion elements (heaters), piezoelectric elements, or the like. The platen 402 is a member that regulates the position of the sheet 12. The printing unit 40 prints an image on the sheet 12 by ejecting ink from the print head 401 of an inkjet system.

The print head 401 may eject each of four color inks: cyan (C), magenta (M), yellow (Y), and black (K). The inks to be ejected may include a white ink used for forming a background, a light color ink, a clear ink, a metallic ink, and a reaction liquid for fixing ink or the like to a print medium. The print head 401 is not limited to a print head of an inkjet system. For example, the print head 401 may be a print head of a laser system. Further, the printing system of the printing unit 40 is not particularly limited. For example, the printing system of the printing unit 40 may be a serial-scan system or a full-line system. In a serial-scan system, an image is printed in association with a conveyance operation of the sheet 12 and scans performed by the print head 401 in the direction intersecting the conveyance direction of the sheet 12. In a full-line system, the print head 401 extending in the direction intersecting the conveyance direction of the sheet 12 is used to print an image while the sheet 12 is continuously conveyed.

FIG. 3 is a block diagram illustrating an example of the configuration of a control system in the printing apparatus 10. The printing apparatus 10 includes the control unit 501 as a control device. The control unit 501 includes the CPU 502, the ROM 503, and the RAM 504.

The CPU 502 is a processing unit for implementing various functions of the printing apparatus 10. The CPU 502 includes at least one processor. The CPU 502 executes various processes by executing programs or activating hardware. Each program is executed by loading the program into the RAM 504. The processing performed by the CPU 502 includes control of the sheet supply units 20, the sheet conveyance unit 30 and the printing unit 40. Further, the CPU 502 writes and reads information related to the sheet 12 to and from the RAM 504.

The ROM 503 stores various kinds of data. For example, the ROM 503 stores a program for the CPU 502 to execute processing. This program includes a device driver or the like. Further, the ROM 503 stores data necessary for the operation of the printing apparatus 10.

The RAM 504 is used as a work area for the CPU 502. That is, data necessary for the CPU 502 to execute processing is stored. This data also includes programs. The RAM 504 can also be used as a temporary storage area for data.

Further, the control unit 501 includes a storage device (not illustrated in the drawings) such as a hard disk drive device. In the storage device, various kinds of driver software, various kinds of application software, and the like are recorded (stored).

The control unit 501 is connected to the input/output interface 510. The input/output interface 510 can transmit various kinds of information between the control unit 501 and the operation panel 14. For example, the input/output interface 510 transmits information related to the types of the sheets 12, information related to the widths of the sheets 12, various kinds of setting information, and the like from the operation panel 14 to the control unit 501. Further, the input/output interface 510 can transmit various kinds of information between the control unit 501 and the host device 520. For example, the input/output interface 510 transmits a print job including PDL data for printing an image on the sheet 12 using the printing unit 40 from the host device 520 to the control unit 501. Note that the PDL data is data written using a page description language (PDL).

The host device 520 is an information processing device capable of processing various kinds of information. The host device 520 is located outside the printing apparatus 10. The host device 520 includes the printing apparatus driver 521. The printing apparatus driver 521 can exchange various kinds of information with the printing apparatus 10. The printing apparatus driver 521 can cause the printing apparatus 10 to print an image onto a print medium. For example, the printing apparatus driver 521 generates a print job including PDL data for printing an image on the sheet 12 using the printing unit 40, and supplies the print job to the printing apparatus 10 via the input/output interface 510.

The control unit 501 is connected to each unit of the sheet supply units 20. The units of each sheet supply unit 20 include the supply motor 270, the rotation detection mechanism 280, and the outer periphery detection mechanism 290.

The supply motor 270 is a motor that rotates the roll 13 in the first rotation direction C1 or the second rotation direction C2 (see FIG. 2). If the roll 13 rotates in the first rotation direction C1, the sheet 12 is fed out from the roll 13 and advances in the conveyance direction. That is, the first rotation direction C1 corresponds to the supply direction in which the sheet 12 is supplied. On the other hand, the second rotation direction C2 corresponds to the winding direction in which the sheet 12 is wound. The supply motor 270 drives a member used for setting the roll 13 in the roll holding unit 11 in a rotatable manner (see FIG. 1) under the control of the control unit 501, and rotates the roll 13 in the first rotation direction C1 or the second rotation direction C2. In the example of FIG. 2, the members used for setting the rolls 13 in the roll holding units 11 are the attachments 110.

Each rotation detection mechanism 280 is a detection mechanism that detects the rotation angle of the roll 13. In the example of FIG. 2, the rotation detection mechanisms 280 are attached to the flapper bodies 211. In a case where the rotation detection mechanisms 280 are attached to the flapper bodies 211, each rotation detection mechanism 280 determines one rotation of the roll 13 by detecting the leading end of the sheet 12 peeled (separated) from the roll 13. That is, each rotation detection mechanism 280 detects, as the rotation angle corresponding to the roll 13 that has made one rotation, the rotation angle from the point in time at which the leading end of the sheet 12 that has slightly peeled off from the roll 13 is detected until the point in time at which the leading end of the sheet 12 is detected again. In a case where each rotation detection mechanism 280 detects the leading end of the sheet 12, it is preferable that the roll 13 is rotated in the second rotation direction C2. This is because the sheet 12 is not fed out from the roll 13, and thus the rotation detection mechanism 280 can properly detect the leading end of the sheet 12. Each rotation detection mechanism 280 may have the detection roller 281 that can come into contact with the leading end of the sheet 12 and a rotary encoder (not illustrated in the drawings) attached to the detection roller 281. The rotation detection mechanism 280 detects the leading end of the sheet 12, based on a signal output from the rotary encoder upon rotation of the detection roller 281 making contact with the leading end of the sheet 12.

Each rotation detection mechanism 280 is not limited to a mechanism that detects the leading end of the sheet 12 to detect the rotation angle of the roll 13. For example, each rotation detection mechanism 280 may detect the angle at which the supply motor 270 rotates the roll 13, based on a signal obtained from a rotary encoder attached to the supply motor 270. Alternatively, in a case where the supply motor 270 is a pulse motor or the like, the rotation detection mechanism 280 may detect the rotation angle of the roll 13, based on a driving pulse of the supply motor 270. The rotation angle detected by each rotation detection mechanism 280 is supplied to the control unit 501. Note that the rotary encoder is not limited to being attached to the supply motor 270, but may also be attached to the shaft of each roll holding unit 11 that holds the roll 13.

Each outer periphery detection mechanism 290 is a detection mechanism that detects the outer peripheral length, which is the length of the outer periphery of the roll 13. Each outer periphery detection mechanism 290 detects the outer peripheral length of the roll 13, based on a signal output from a rotary encoder attached to the follower rotating body 250.

Each outer periphery detection mechanism 290 is not limited to a mechanism that detects the outer peripheral length of the roll 13, based on a signal output from a rotary encoder. For example, each outer periphery detection mechanism 290 may detect the outer peripheral length of the roll 13 by reading reflected light from the outer periphery of the roll 13 using an optical sensor or the like. The outer peripheral length of the roll 13 detected by the outer periphery detection mechanism 290 is supplied to the control unit 501.

Further, the control unit 501 is also connected to the sheet conveyance unit 30 and the printing unit 40. For example, the conveyance motor 303 of the sheet conveyance unit 30 drives the conveyance roller 302 under the control of the control unit 501, and rotates the conveyance roller 302 in the normal rotation direction A1 or the reverse rotation direction A2. The print head 401 of the printing unit 40 ejects ink from ejection ports under the control of the control unit 501.

### <Automatic Sheet Supply Processing>

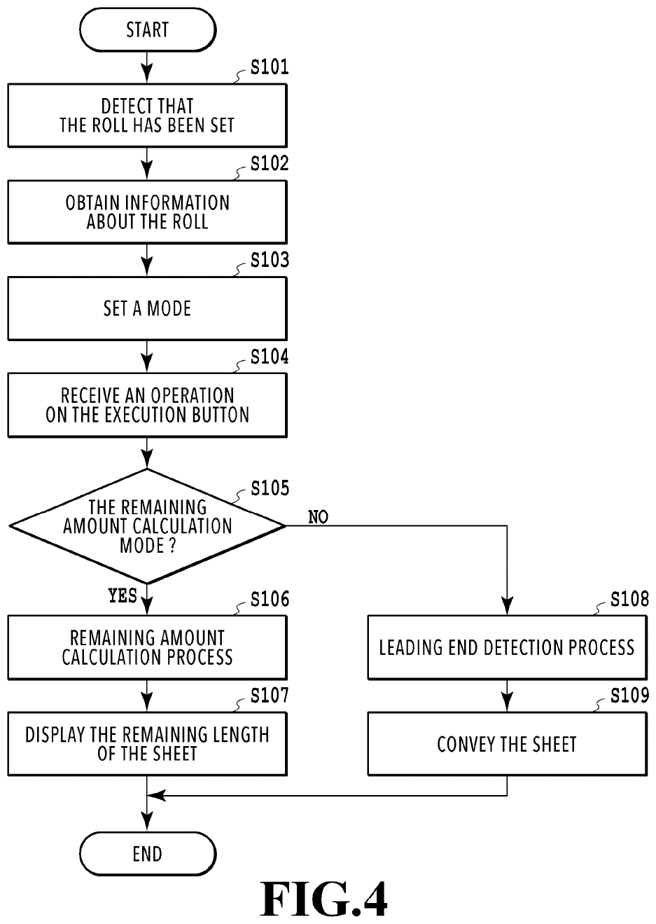

Next, a description is given about the automatic sheet supply processing in the first embodiment. FIG. 4 is a flowchart illustrating an example of the automatic sheet supply processing in the first embodiment. The series of processes (the automatic sheet supply processing) illustrated in the flowchart of FIG. 4 is implemented by the CPU 502 of the control unit 501 reading out a program stored in the ROM 503 or the like into the RAM 504 and executing it. Note that part or all of the functions in the steps of FIG. 4 may be implemented by hardware such as an ASIC or an electronic circuit. The symbol “S” in the description of each process indicates that it is a step in the flowchart diagram (the same applies hereinafter to the flowchart diagrams in this specification). In the present embodiment, a description is given about a technology that makes it possible to know the remaining length of the sheet 12 on each roll 13 without feeding out the sheet 12 from the roll 13. Further, the automatic sheet supply processing is started in the standby state after the printing apparatus 10 is activated. It is also possible to start the automatic sheet supply processing in a sleep state after the printing apparatus 10 is stopped.

First, in S101, the control unit 501 detects that the roll 13 has been set by the user. At this time, the control unit 501 detects that the roll 13 has been set in the roll holding unit 11 using a roll presence/absence sensor (not illustrated in the drawings) attached to the roll holding unit 11.

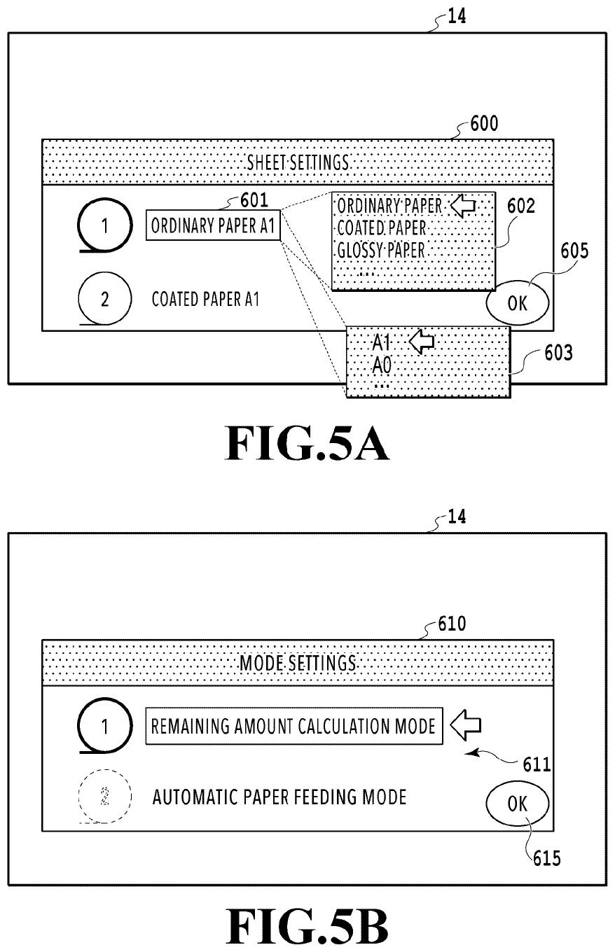

In S102, the control unit 501 obtains information related to the roll 13 that is set in the roll holding unit 11, based on an instruction input by the user. At this time, the control unit 501 displays the paper setting screen 600 (see FIG. 5A described later) on the display unit of the operation panel 14. The user utilizes the paper setting screen 600 displayed on the display unit of the operation panel 14 to input, to the operation panel 14, the information related to the roll 13 that is set in the roll holding unit 11. The control unit 501 obtains, via the operation panel 14 and the input/output interface 510, the information related to the roll 13 based on the instruction input by the user. The information related to the roll 13 includes information related to the type of the sheet 12 and information related to the width of the sheet 12. The inner diameter of the roll 13 is available in a variety of sizes, such as 2 inches and 3 inches. A correspondence between the type of the roll 13 and the inner diameter of the roll 13 is maintained, such that the inner diameter of the roll 13 is determined if the type of the roll 13 is designated. This allows the control unit 501 to specify the later-described inner diameter D2 of the roll 13.

FIG. 5A and FIG. 5B are schematic diagrams illustrating examples of a screen displayed on the operation panel 14 in the first embodiment. FIG. 5A is a schematic diagram illustrating an example of the paper setting screen 600 displayed on the operation panel 14. As illustrated in FIG. 5A, the paper setting screen 600 includes the type display area 601, the paper selection display area 602, the size selection display area 603, and the “OK” button 605 arranged thereon. In the type display area 601, the type of the sheet 12 and the width of the sheet 12 currently set for each of the rolls 13 held by the roll holding units 11 at the upper portion and the lower portion are displayed. For example, in the type display area 601 in FIG. 5A, it is displayed that, in the roll 13 held by the roll holding unit 11 at the upper portion, the type of the sheet 12 is set to ordinary paper and the width of the sheet 12 is set to A1-size width. In the paper selection display area 602, the selectable types of the sheet 12 are displayed. For example, in the paper selection display area 602 in FIG. 5A, ordinary paper, coated paper, glossy paper, and the like are displayed as the selectable types of the sheet 12. In the size selection display area 603, the selectable widths of the sheet 12 are displayed. For example, in the size selection display area 603 in FIG. 5A, the A1-size width, A0-size width, and the like are displayed as the selectable widths of the sheet 12. The “OK” button 605 is an operation button for inputting an instruction relating to the type of the sheet 12 and the width of the sheet 12. By operating (for example, pressing) the “OK” button 605, the type of sheet 12 selected in the paper selection display area 602 and the width of the sheet 12 selected in the size selection display area 603 are input.

Returning to FIG. 4, in S103, the control unit 501 sets the mode to either the remaining amount calculation mode or the automatic paper feeding mode, based on an instruction input by the user. At this time, the control unit 501 displays the mode selection screen 610 (see FIG. 5B described later) on the display unit of the operation panel 14. The user utilizes the mode selection screen 610 displayed on the display unit of the operation panel 14 to input, to the operation panel 14, an instruction for setting the mode to the remaining amount calculation mode or the automatic paper feeding mode. The control unit 501 sets the mode based on the instruction input by the user to the operation panel 14. The automatic paper feeding mode is a mode in which the sheet 12 is automatically fed from the roll 13 to print an image, in other words, an image printing mode. The remaining amount calculation mode is a mode in which the roll 13 is set for checking the remaining length of the sheet 12 on the roll 13.

FIG. 5B is a schematic diagram illustrating an example of the mode selection screen 610 displayed on the operation panel 14. As illustrated in FIG. 5B, the mode selection screen 610 includes the mode selection display area 611 and the “OK” button 615 arranged thereon. In the mode selection display area 611, the selectable modes are displayed. For example, in the mode selection display area 611 in FIG. 5B, the remaining amount calculation mode and the automatic paper feeding mode are displayed as the selectable modes. The “OK” button 615 is an operation button for inputting an instruction for setting the mode to the remaining amount calculation mode or the automatic paper feeding mode. By operating (for example, pressing) the “OK” button 615, the mode selected in the mode selection display area 611 is set.

Returning to FIG. 4, in S104, the control unit 501 detects that the user has operated (for example, pressed) an execution button (not illustrated in the drawings), and accepts the operation of the execution button. The execution button is arranged, for example, on a UI (user interface) screen displayed on the operation panel 14. Note that the execution button may be the aforementioned “OK” button 615.

In S105, the control unit 501 determines whether or not the set mode is the remaining amount calculation mode. If the set mode is the remaining amount calculation mode, that is, if the determination made in S105 is YES, the processing proceeds to S106. If the set mode is not the remaining amount calculation mode, that is, if the determination made in S105 is NO, the processing proceeds to S108.

In S106, the control unit 501 executes a remaining amount calculation process. The remaining amount calculation process is described later.

In S107, the control unit 501 displays the remaining length of the sheet 12 on the roll 13, which is calculated in the remaining amount calculation process, on the display unit of the operation panel 14. The control unit 501 displays the remaining length of the sheet 12 on the display unit of the operation panel 14, and then ends the processing.

In S108, the control unit 501 executes a leading end detection process. In the leading end detection process, the control unit 501 causes the supply motor 270 to rotate the roll 13 in the second rotation direction C2, which is opposite to the rotation direction during conveyance. At this time, the detection roller 281 of each rotation detection mechanism 280 detects the leading end of the sheet 12 separated from the follower roller 213 of the separation flapper 210. Then, the control unit 501 causes the supply motor 270 to rotate the roll 13 in the first rotation direction C1, thereby inserting the leading end of the sheet 12 pulled out from the roll 13 into the sheet supply port between the arm member 220 and the separation flapper 210, so as to feed it out to the sheet conveyance unit 30.

In S109, the control unit 501 causes the sheet conveyance unit 30 to convey the sheet 12 to the printing unit 40, and causes the printing unit 40 to print an image. At this time, the conveyance motor 303 of the sheet conveyance unit 30 drives the conveyance roller 302 under the control of the control unit 501, and rotates the conveyance roller 302 in the normal rotation direction A1. The print head 401 of the printing unit 40 ejects ink from ejection ports under the control of the control unit 501. The control unit 501 causes the printing unit 40 to print the image, and then ends the processing.

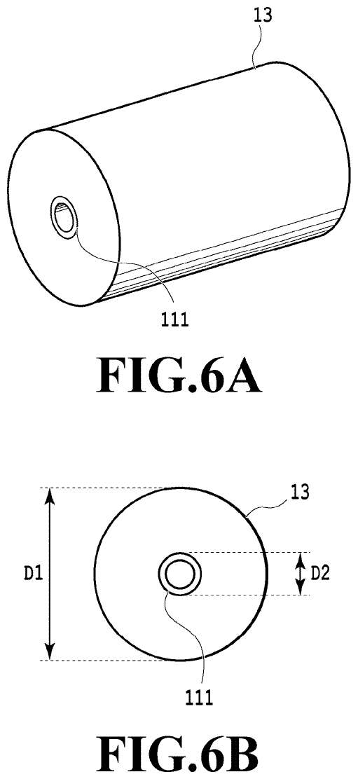

Hereinafter, a description is given about the remaining amount calculation process of S106. FIG. 6A and FIG. 6B are schematic diagrams of the roll 13. FIG. 6A is a perspective view of the roll 13. FIG. 6B is a side view of the roll 13. As illustrated in FIG. 6B, the outer diameter of the roll 13 is denoted as D1, and the inner diameter of the roll 13 is denoted as D2. Note that the inner diameter D2 of the roll 13 indicates the diameter of the hollow hole portion 111 of the roll 13. Additionally, the rotation angle of the roll 13 rotated in the second rotation direction C2, which is detected by the rotation detection mechanism 280, is defined as θ1 (unit: degrees). The length detected by the outer periphery detection mechanism 290 in a case where the follower rotating body 250 rotates once is defined as d1, and the number of rotations of the follower rotating body 250 is defined as r1. Note that the rotation angle θ1 of the roll 13 is not limited to the angle corresponding to a case where the follower rotating body 250 rotates once, but may be any angle corresponding to a case where the follower rotating body 250 rotates at least once. The length d1 detected by the outer periphery detection mechanism 290 in a case where the follower rotating body 250 rotates once is the length of the outer periphery of the follower rotating body 250. In a case where the rotation detection mechanism 280 detects the rotation angle of the roll 13 by detecting the leading end of the sheet 12, the rotation angle θ1 of the roll 13 after one rotation is 360 degrees.

In the remaining amount calculation process, the control unit 501 calculates the outer peripheral length L1, which is the length of the outer periphery of the roll 13, based on the rotation angle θ1 of the roll 13, the length d1 detected by the outer periphery detection mechanism 290, and the number of rotations r1 of the follower rotating body 250. The outer peripheral length L1 of the roll 13 is calculated, for example, using the following formula (1).

$$L 1 = ( 360 / θ 1 ) \times d 1 \times r 1 \qquad ( 1 )$$

The control unit 501 calculates the outer diameter D1 of the roll 13, based on the outer peripheral length L1 of the roll 13 detected by utilizing the outer periphery detection mechanism 290. The outer diameter D1 of the roll 13 is calculated, for example, using the following formula (2).

$$D 1 = L 1 / π \qquad ( 2 )$$

The control unit 501 calculates the remaining length L2 of the sheet 12 on the roll 13 held by the roll holding unit 11, based on the sheet thickness t, the inner diameter D2 of the roll 13, and the outer diameter D1 of the roll 13. The inner diameter D2 of the roll 13 is derived from the type of the roll 13 (or the sheet 12) set by the user. The sheet thickness t is derived from the type of the roll 13 (or the sheet 12) set by the user. The remaining length L2 of the sheet on the roll 13 is calculated, for example, using the following formula (3).

$$L 2 = π / 4 \times ( D {1}^{2} - D {2}^{2} ) / t \qquad ( 3 )$$

The control unit 501 displays the remaining length L2 of the sheet 12 on the roll 13, which is calculated in a calculation process utilizing the formula (3) or the like, on the display unit of the operation panel 14. In this way, the control unit 501 has the function as a notification unit that provides a notification about the remaining length L2 of the sheet 12 on the roll 13. Note that the formula (3) is a known calculation formula that can calculate the length (a remaining amount) of a wound member, based on the area and thickness of a side surface of the wound member.

Further, the inner diameter D2 of the roll 13 is determined based on the type of the roll 13 set by the user; however, there is no such limitation. For example, the inner diameter D2 of the roll 13 may be determined using a sensor that detects the type of the attachment 110 that holds the roll 13. The inner diameter D2 of the roll 13 may be determined using a sensor that detects the presence or absence of the attachment 110.

The rotation angle θ1 of the roll 13 is detected by detecting the leading end of the sheet 12 on the roll 13 rotated in the second rotation direction C2; however, there is no such limitation. For example, as described above, the rotation angle θ1 of the roll 13 may be detected by using a rotary encoder or the like to detect the angle at which the supply motor 270 rotates the roll 13 held by the roll holding unit 11.

The outer peripheral length L1 of the roll 13 is detected based on the number of rotations r1 of the follower rotating body 250, which is rotatable while being in pressure contact with the outer peripheral portion of the roll 13 held by the roll holding unit 11; however, there is no such limitation. For example, as described above, the outer peripheral length L1 of the roll 13 may be detected by reading reflected light from the outer periphery of the roll 13 with an optical sensor or the like.

As described above, according to the first embodiment, it is possible to know the remaining length of the sheet 12 on the roll 13 without feeding out the sheet 12 from the roll 13. That is, the present embodiment includes a notification unit that provides a notification about the remaining length L2 of the sheet 12 on the roll 13 held by the roll holding unit 11, based on the outer diameter D1 of the roll 13. For example, the control unit 501 may have the function as a notification unit that provides a notification about the remaining length L2 of the sheet 12 on the roll 13. The control unit 501 calculates the remaining length L2 of the sheet 12 on the roll 13 held by the roll holding unit 11, based on the sheet thickness t, the inner diameter D2 of the roll 13, and the outer diameter D1 of the roll 13. The outer diameter D1 of the roll 13 is obtained by the rotation detection mechanism 280 and the outer periphery detection mechanism 290, which serve as obtaining units. For example, the outer diameter D1 of the roll 13 held by the roll holding unit 11 is obtained based on a rotation angle of the roll 13 rotated in the second rotation direction C2, which is detected by the rotation detection mechanism 280, and an outer peripheral length of the roll 13, which is detected by the outer periphery detection mechanism 290. Accordingly, it is possible to obtain the outer diameter D1 of the roll 13 in a state before the sheet 12 is fed out from the roll 13, and to calculate the remaining length L2 of the sheet 12 on the roll 13. Therefore, even in a case where the roll 13 is replaced while the remaining length L2 of the sheet 12 on the roll 13 is insufficient, there is no need to rewind the sheet 12. In this way, it is possible to know the remaining length of the sheet 12 on the roll 13 without feeding out the sheet 12 from the roll 13.

### Second Embodiment

Next, a description is given about the second embodiment. Since each of the members in the second embodiment has the same configuration as that in the above-described first embodiment, the description is given with the same signs as those given to the respective members in the above-described first embodiment. The printing apparatus 10 according to the second embodiment is configured similarly to the printing apparatus 10 according to the first embodiment.

### <Automatic Sheet Supply Processing>

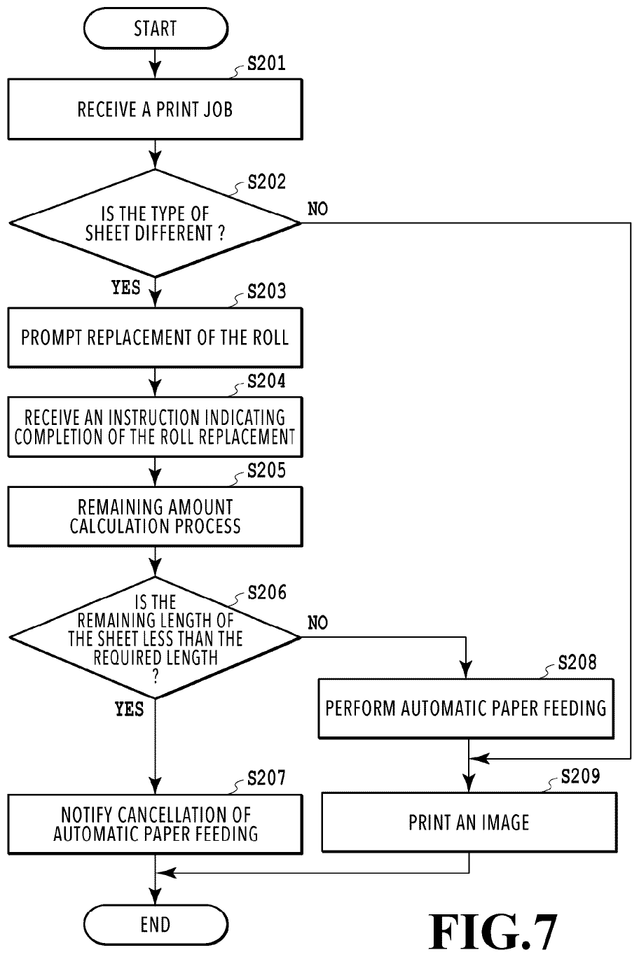

Next, a description is given about the automatic sheet supply processing in the second embodiment. FIG. 7 is a flowchart illustrating an example of the automatic sheet supply processing in the second embodiment. In the second embodiment, a description is given about automatic sheet supply processing that is executed in a case where the control unit 501 receives a print job. At the time of starting printing, the user utilizes the printing apparatus driver 521 of the host device 520 to select an image to be printed. Upon selecting an image to be printed, the user utilizes the printing apparatus driver 521 to set the type of print medium (sheet), an orientation of the image, the number of sheets to be printed, etc., and then sends a print job to perform printing. Note that, in the second embodiment, the automatic sheet supply processing starts in a state where the roll 13 is set in the roll holding unit 11. It is assumed that the aforementioned remaining amount calculation process has been executed at the time the roll 13 is set in the roll holding unit 11.

First, in S201, the control unit 501 receives a print job. At this time, for example, the control unit 501 receives the print job from the printing apparatus driver 521 of the host device 520 via the input/output interface 510.

In S202, the control unit 501 determines whether or not the type of sheet designated in the print job is different from the type of the sheet 12 on the roll 13 set in the roll holding unit 11. Note that the type of the sheet 12 on the roll 13 set in the roll holding unit 11 is set by the user using the operation panel 14, for example. If the type of sheet designated in the print job is different from the type of the sheet 12 on the roll 13 set in the roll holding unit 11, that is, if the determination made in S202 is YES, the processing proceeds to S203. If the type of sheet designated in the print job is the same as the type of the sheet 12 on the roll 13 set in the roll holding unit 11, that is, if the determination made in S202 is NO, the processing proceeds to S209.

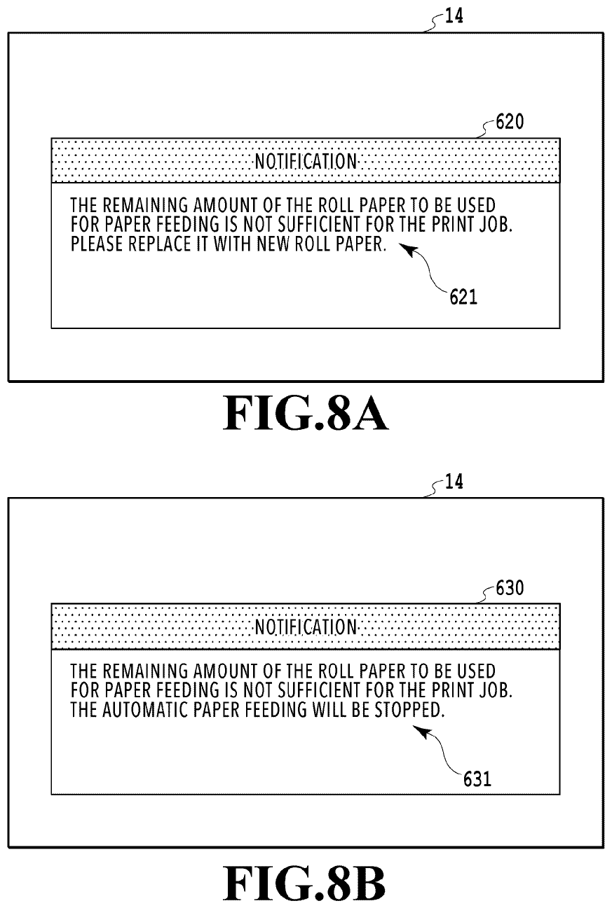

In S203, the control unit 501 displays the replacement notification screen 620 for prompting replacement of the roll 13 (see FIG. 8A described later) on the display unit of the operation panel 14. Note that the replacement notification screen 620 may be displayed on a display unit of the host device 520 by the printing apparatus driver 521 of the host device 520.

FIG. 8A and FIG. 8B are schematic diagrams illustrating examples of a screen displayed on the operation panel 14 in the second embodiment. FIG. 8A is a schematic diagram illustrating an example of the replacement notification screen 620 displayed on the operation panel 14. As illustrated in FIG. 8A, the replacement message display area 621 is arranged on the replacement notification screen 620. In the replacement message display area 621, a message prompting replacement of the roll 13, such as “Please replace it with new roll paper.”, is displayed.

Returning to FIG. 7, in S204, the control unit 501 receives an instruction indicating that replacement of the roll 13 set in the roll holding unit 11 has been completed. The instruction to complete the replacement is given by the user through pressing a completion button, for example. Further, after replacing the roll 13, the user inputs, to the operation panel 14, information related to the replaced roll 13 set in the roll holding unit 11. At this time, as in the first embodiment, the control unit 501 obtains, via the operation panel 14 and the input/output interface 510, the information related to the replaced roll 13 based on an instruction input by the user.

In S205, as in the first embodiment, the control unit 501 executes the remaining amount calculation process.

In S206, the control unit 501 compares whether or not the remaining length of the sheet 12 calculated in the remaining amount calculation process is less than the length of the sheet required for the print job. Note that the length of the sheet required for a print job is also referred to as the print length of the print job. If the remaining length of the sheet 12 calculated in the remaining amount calculation process is less than the length of the sheet required for the print job, that is, if the determination made in S206 is YES, the processing proceeds to S207. If the remaining length of the sheet 12 calculated in the remaining amount calculation process is equal to or more than the length of the sheet required for the print job, that is, if the determination made in S206 is NO, the processing proceeds to S208.

In S207, the control unit 501 provides a notification indicating that the remaining length of the sheet 12 is short, and displays the cancellation notification screen 630 (see FIG. 8B described below) on the display unit of the operation panel 14 as a notification indicating cancellation of automatic paper feeding. At this time, the control unit 501 controls the supply motor 270 not to rotate the roll 13 in the first rotation direction C1, thereby stopping automatic paper feeding. The control unit 501 displays the cancellation notification screen 630 on the display unit of the operation panel 14, and then ends the processing. Note that the cancellation notification screen 630 may be displayed on a display unit of the host device 520 by the printing apparatus driver 521 of the host device 520.

FIG. 8B is a schematic diagram illustrating an example of the cancellation notification screen 630 displayed on the operation panel 14. As illustrated in FIG. 8B, the cancellation message display area 631 is arranged on the cancellation notification screen 630. In the cancellation message display area 631, a message related to the remaining length of the sheet 12, such as “The remaining amount of the roll paper to be used for paper feeding is not sufficient for the print job.” In addition, in the cancellation message display area 631, a message as a notification of cancellation of automatic paper feeding, such as “The automatic paper feeding will be stopped.”, is displayed.

Returning to FIG. 7, in S208, the control unit 501 performs automatic paper feeding. The control unit 501 causes the supply motor 270 to rotate the roll 13 in the first rotation direction C1, thereby inserting the leading end of the sheet 12 pulled out from the roll 13 into the sheet supply port between the arm member 220 and the separation flapper 210, so as to feed it out to the sheet conveyance unit 30. Then, the control unit 501 causes the sheet conveyance unit 30 to convey the sheet 12 to the printing unit 40.

In S209, the control unit 501 causes the printing unit 40 to print the image. At this time, the print head 401 of the printing unit 40 ejects ink from ejection ports under the control of the control unit 501. The control unit 501 causes the printing unit 40 to print the image, and then ends the processing.

As described above, according to the second embodiment, as in the first embodiment, it is possible to know the remaining length of the sheet 12 on the roll 13 without feeding out the sheet 12 from the roll 13.

### Third Embodiment

Next, a description is given about the third embodiment. Since each of the members in the third embodiment has the same configuration as that in the above-described first embodiment, the description is given with the same signs as those given to the respective members in the above-described first embodiment. The printing apparatus 10 according to the third embodiment is configured similarly to the printing apparatus 10 according to the first embodiment.

### <Automatic Sheet Supply Processing>

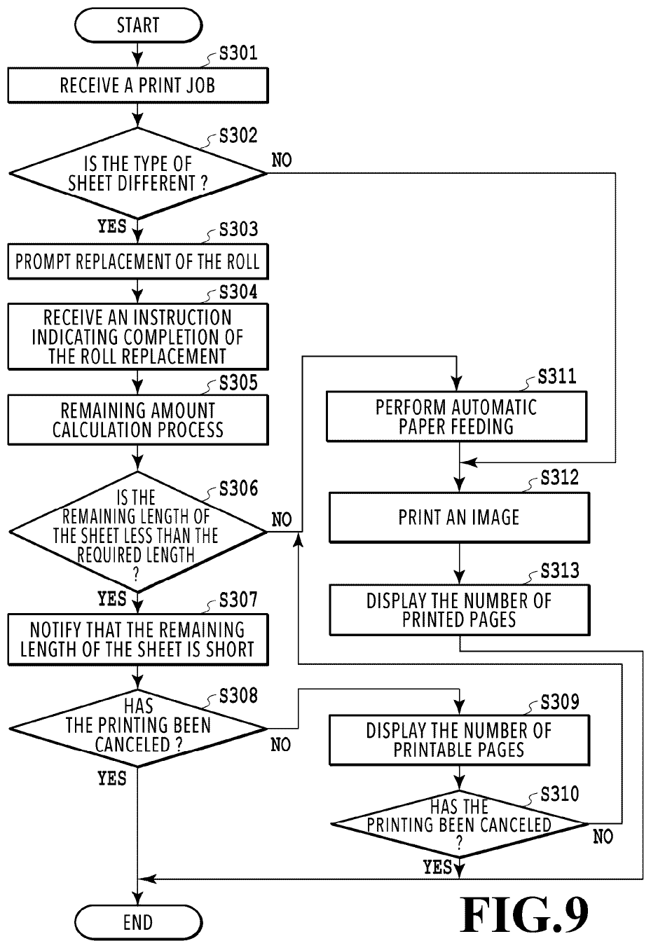

Next, a description is given about the automatic sheet supply processing in the third embodiment. FIG. 9 is a flowchart illustrating an example of the automatic sheet supply processing in the third embodiment. In the third embodiment, as in the second embodiment, a description is given about automatic sheet supply processing that is executed in a case where the control unit 501 receives a print job. In the third embodiment, in a case where the remaining length of the sheet 12 calculated in the remaining amount calculation process is short, it is possible to not only cancel the printing but also print only the printable number of pages.

First, in S301, as in the second embodiment, the control unit 501 receives a print job.

In S302, as in the second embodiment, the control unit 501 determines whether or not the type of sheet designated in the print job is different from the type of the sheet 12 on the roll 13 set in the roll holding unit 11. If the type of sheet designated in the print job is different from the type of the sheet 12 on the roll 13 set in the roll holding unit 11, that is, if the determination made in S302 is YES, the processing proceeds to S303. If the type of sheet designated in the print job is the same as the type of the sheet 12 on the roll 13 set in the roll holding unit 11, that is, if the determination made in S302 is NO, the processing proceeds to S312.

In S303, as in the second embodiment, the control unit 501 displays the replacement notification screen 620 for prompting replacement of the roll 13 (see FIG. 8A) on the display unit of the operation panel 14. Note that the replacement notification screen 620 may be displayed on a display unit of the host device 520 by the printing apparatus driver 521 of the host device 520.

In S304, as in the second embodiment, the control unit 501 receives an instruction indicating that replacement of the roll 13 set in the roll holding unit 11 has been completed.

In S305, as in the first embodiment, the control unit 501 executes a remaining amount calculation process.

In S306, the control unit 501 compares whether or not the remaining length of the sheet 12 calculated in the remaining amount calculation process is less than the length of sheet required for the print job. If the remaining length of the sheet 12 calculated in the remaining amount calculation process is less than the length of sheet required for the print job, that is, if the determination made in S306 is YES, the processing proceeds to S307. If the remaining length of the sheet 12 calculated in the remaining amount calculation process is equal to or more than the length of sheet required for the print job, that is, if the determination made in S306 is NO, the processing proceeds to S311.

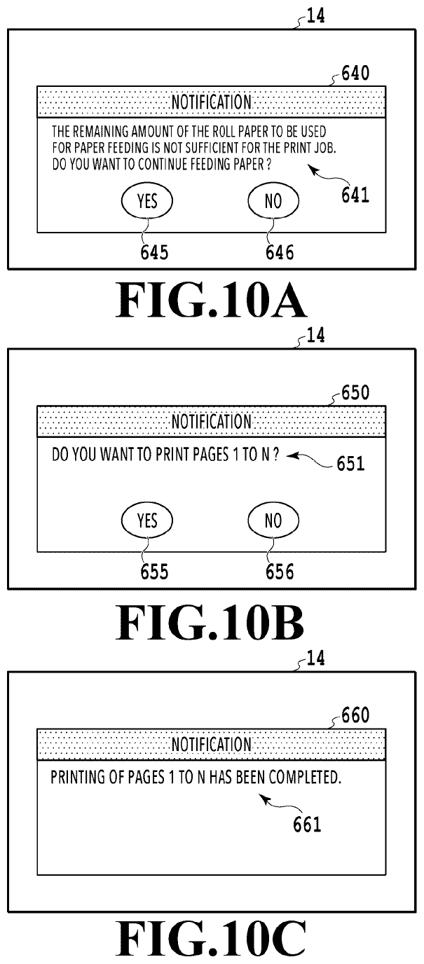

In S307, the control unit 501 provides a notification indicating that the remaining length of the sheet 12 is short, and displays the cancellation selection screen 640 to allow the user to select whether or not to cancel the printing (see FIG. 10A described below) on the display unit of the operation panel 14. Note that the cancellation selection screen 640 may be displayed on a display unit of the host device 520 by the printing apparatus driver 521 of the host device 520.

FIG. 10A to FIG. 10C are schematic diagrams illustrating examples of a screen displayed on the operation panel 14 in the third embodiment. FIG. 10A is a schematic diagram illustrating an example of the cancellation selection screen 640 displayed on the operation panel 14. As illustrated in FIG. 10A, the cancellation selection screen 640 includes the selection message display area 641, the “YES” button 645, and the “NO” button 646 arranged thereon. In the selection message display area 641, a message related to the remaining length of the sheet 12, such as “The remaining amount of the roll paper to be used for paper feeding is not sufficient for the print job.”, is displayed. In addition, in the selection message display area 641, a message prompting to select whether or not to cancel the printing, such as “Do you want to continue feeding paper?”, is displayed. The “YES” button 645 is an operation button for inputting an instruction to perform printing. The user can perform the printing by operating (for example, pressing) the “YES” button 645. The “NO” button 646 is an operation button for inputting an instruction to cancel the printing. The user can cancel the printing by operating (for example, pressing) the “NO” button 646.

Returning to FIG. 9, in S308, the control unit 501 determines whether or not an operation to cancel the printing has been performed. If an operation to cancel the printing has been performed, that is, if the determination made in S308 is YES, the processing ends. If an operation to perform the printing has been performed, that is, if the determination made in S308 is NO, the processing proceeds to S309.

In S309, the control unit 501 displays the page number display screen 650 on which the number of printable pages is displayed (see FIG. 10B described later) on the display unit of the operation panel 14. Note that the page number display screen 650 may be displayed on a display unit of the host device 520 by the printing apparatus driver 521 of the host device 520. The number of printable pages is calculated based on the remaining length of the sheet 12 calculated in the remaining amount calculation process and information related to the number of pages included in the print job.

FIG. 10B is a schematic diagram illustrating an example of the page number display screen 650 displayed on the operation panel 14. As illustrated in FIG. 10B, the page number display screen 650 includes the page number display area 651, the “YES” button 655, and the “NO” button 656 arranged thereon. In the page number display area 651, a message indicating the number of printable pages, such as “Do you want to print pages 1 to N?”, is displayed. The “YES” button 655 is an operation button for inputting an instruction to perform printing for only the number of printable pages. The user can perform the printing for only the number of printable pages by operating (for example, pressing) the “YES” button 655. The “NO” button 656 is an operation button for inputting an instruction to cancel the printing. The user can cancel the printing by operating (for example, pressing) the “NO” button 656.

Returning to FIG. 9, in S310, the control unit 501 determines whether or not an operation to cancel the printing has been performed. If an operation to cancel the printing has been performed, that is, if the determination made in S310 is YES, the processing ends. If an operation to perform the printing for only the number of printable pages has been performed, that is, if the determination made in S310 is NO, the processing proceeds to S311.

In S311, as in the second embodiment, the control unit 501 performs automatic paper feeding.

In S312, as in the second embodiment, the control unit 501 causes the printing unit 40 to print the image. If the remaining length of the sheet 12 calculated in the remaining amount calculation process is less than the length of sheet required for the print job, the printing unit 40 prints images for the number of printable pages under the control of the control unit 501.

In S313, the control unit 501 displays the print result display screen 660 on which the number of printed pages is displayed (see FIG. 10C described later) on the display unit of the operation panel 14. Note that the print result display screen 660 may be displayed on a display unit of the host device 520 by the printing apparatus driver 521 of the host device 520. The control unit 501 displays the print result display screen 660 on the display unit of the operation panel 14, and then ends the processing.

FIG. 10C is a schematic diagram illustrating an example of the print result display screen 660 displayed on the operation panel 14. As illustrated in FIG. 10C, the print result display screen 660 includes the print result display area 661 arranged thereon. In the print result display area 661, a message indicating the number of printed pages, such as “Printing of pages 1 to N has been completed.”, is displayed.

As described above, according to the third embodiment, as in the first embodiment, it is possible to know the remaining length of the sheet 12 on the roll 13 without feeding out the sheet 12 from the roll 13. Further, in the third embodiment, it is possible to perform printing for the number of printable pages even in a case where the remaining length of the sheet 12 calculated in the remaining amount calculation process is less than the length of sheet required for the print job.

In each of the above-described embodiments, the control unit 501 of the printing apparatus 10 executes automatic sheet supply processing; however, there is no such limitation. For example, it is also possible that the printing apparatus driver 521 of the host device 520 executes part of automatic sheet supply processing (for example, a remaining amount calculation process), and the control unit 501 of the printing apparatus 10 executes the other processes in the automatic sheet supply processing. In this case, the above-mentioned execution button may be arranged on a UI screen displayed on a display unit of the host device 520.

In each of the above-described embodiments, the outer diameter D1 of the roll 13 is obtained by the rotation detection mechanism 280 and the outer periphery detection mechanism 290, which serve as obtaining units; however, there is no such limitation. For example, it is also possible that the outer diameter D1 of the roll 13 is measured using what is termed as an image dimension measuring machine.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to know the remaining length of a sheet on a roll without feeding out the sheet from the roll.

This application claims the benefit of Japanese Patent Application No. 2025-005357, filed Jan. 15, 2025, which is hereby incorporated by reference herein in its entirety.

What is claimed is:

1. A printing apparatus comprising:
a roll holding unit configured to hold a roll on which a sheet is wound, such that the roll is rotatable in a first rotation direction for feeding out the sheet and in a second rotation direction opposite to the first rotation direction;
a motor configured to rotate the roll held by the roll holding unit in the first rotation direction or the second rotation direction;
a control unit configured to control the motor;
an obtaining unit configured to obtain an outer diameter of the roll held by the roll holding unit; and
a notification unit configured to provide a notification about a remaining length of the sheet on the roll held by the roll holding unit, based on the outer diameter of the roll obtained by the obtaining unit.

2. The printing apparatus according to claim 1,
wherein the control unit calculates the remaining length of the sheet on the roll held by the roll holding unit, based on a thickness of the sheet, an inner diameter of the roll, and the outer diameter of the roll obtained by the obtaining unit.

3. The printing apparatus according to claim 1, further comprising
a printing unit configured to print an image on the sheet fed out from the roll held by the roll holding unit,
wherein the control unit controls the motor and the printing unit.

4. The printing apparatus according to claim 1,
wherein, among a remaining amount detection mode and an image printing mode, in a case where the remaining amount detection mode is set, the notification unit provides the notification about the remaining length of the sheet on the roll held by the roll holding unit.

5. The printing apparatus according to claim 4, further comprising
a printing unit configured to print an image on the sheet fed out from the roll held by the roll holding unit,
wherein, in a case where the image printing mode is set, the control unit causes the printing unit to print an image.

6. The printing apparatus according to claim 1,
wherein the obtaining unit includes a rotation detection mechanism configured to detect a rotation angle of the roll rotated in the second rotation direction and an outer periphery detection mechanism configured to detect an outer peripheral length, which is a length of an outer periphery of the roll held by the roll holding unit, and
wherein, based on the rotation angle and the outer peripheral length, the obtaining unit obtains the outer diameter of the roll held by the roll holding unit.

7. The printing apparatus according to claim 6,
wherein the rotation detection mechanism detects the rotation angle by detecting a leading end of the sheet on the roll rotated in the second rotation direction.

8. The printing apparatus according to claim 6,
wherein the rotation detection mechanism detects the rotation angle by detecting an angle at which the motor rotates the roll held by the roll holding unit.

9. The printing apparatus according to claim 6,
wherein the outer periphery detection mechanism detects the outer peripheral length, based on the number of rotations of a follower rotating body configured to be rotatable while being in pressure contact with an outer peripheral portion of the roll held by the roll holding unit.

10. The printing apparatus according to claim 1,
wherein, in a case where the remaining length of the sheet on the roll held by the roll holding unit is less than a sheet length required in a print job for printing an image, the notification unit causes a display unit to display the notification about the remaining length of the sheet.

11. The printing apparatus according to claim 1,
wherein, in a case where the remaining length of the sheet on the roll held by the roll holding unit is less than a sheet length required in a print job for printing an image, the control unit controls the motor not to rotate the roll held by the roll holding unit.

12. The printing apparatus according to claim 1,
wherein, in a case where the remaining length of the sheet on the roll held by the roll holding unit is equal to or more than a sheet length required in a print job for printing an image, the control unit controls the motor to rotate the roll held by the roll holding unit.
